(19) United States
(12) Patent Application Publication
(10) Pub. No.: US 2016/0351192 A1
(43) Pub. Date: Dec. 1, 2016

(54) Voice Recognition Device, Voice Control System And Voice Communication System

(71) Applicant: Shenzhen Sigma Microelectronics Co., Ltd., Shenzhen (CN)

(72) Inventors: Zhenquan Chu, Shenzhen (CN); Lijun Tian, Beijing (CN); Bingjie Chen, Beijing (CN)

(21) Appl. No.: 15/167,759

(22) Filed: May 27, 2016

(30) Foreign Application Priority Data
May 28, 2015 (CN) CN201510283670.3

(51) Int. Cl. G10L 15/22; H04R 9/08; H04R 9/02; H04R 7/12; H04R 3/00; H04R 9/06

(52) U.S. Cl. CPC G10L 15/22; H04R 3/00; H04R 9/06; H04R 9/025; H04R 7/127; H04R 9/08; H04R 2307/025; H04R 2307/027; H04R 2307/021; H04R 2400/01; G10L 2015/221

(57) ABSTRACT

A voice recognition device, a voice control system and a voice communication system are disclosed, wherein the voice recognition device includes: a loudspeaker. The loudspeaker includes: a vibration unit, configured to receive an acoustic signal; a conversion unit, configured to convert the acoustic signal into an electric signal; and a processor, connected with the conversion unit and configured to receive the electric signal and recognize the electric signal. The disclosure solves the technical problem that a voice control product contains many devices, and is structured complicatedly.

### CROSS-REFERENCE TO RELATED APPLICATIONS

This application claims the benefit of and priority to Chinese Patent Application No. CN201510283670.3, filed on May 28, 2015, which is incorporated by reference herein in its entirety.

### TECHNICAL FIELD

The disclosure relates to the field of voice recognition, and particularly to a voice recognition device, a voice control system and a voice communication system.

### BACKGROUND

At present, a voice control product mainly includes components such as a loudspeaker (i.e. a sound reproducer), a microphone (i.e. a sound receiver) and an acoustic control induction controller, wherein sound receivers including the microphone and so on function as acoustic sensors to receive an acoustic wave, and as a sound reproducer, the loudspeaker is configured to amplify and play a sound. The voice control product mainly controls a controlled device according to an acoustic command, control connection or disconnection of a circuit of the controlled device.

It's necessary for the existing voice control products to have a receiver to receive acoustic signals, as well as a reproducer to play the sound, which results in a large number of devices in the products, and consequently a complicated structure.

Currently, there is no effective solution yet for the foregoing problem.

### SUMMARY

Embodiments of the disclosure provide a voice recognition device, a voice control system and a voice communication system, so as to at least solve the technical problem that a voice control product contains many devices, and is structured complicatedly.

A voice recognition device is provided according to an aspect of the embodiments of the disclosure, including: a loudspeaker; the loudspeaker includes: a vibration unit, configured to receive an acoustic signal; a conversion unit, configured to convert the acoustic signal into an electric signal; and a processor, connected with the conversion unit and configured to receive the electric signal and recognize the electric signal.

Further, the vibration unit includes: a diaphragm, configured to receive the acoustic signal and generate vibration.

Further, the diaphragm is at least one of the followings: a cone, a paper-based diaphragm, a metal diaphragm, a polymer diaphragm and a composite diaphragm.

Further, the conversion unit includes: a voice coil, fixedly arranged with the diaphragm and vibrating with the vibration of the diaphragm, wherein the voice coil generates the electric signal when vibrating with the diaphragm.

Further, the voice recognition device further includes: a sensor module, connected between the processor and the conversion unit and configured to convert the electric signal into a pulse sequence and output the pulse sequence to the processor.

Further, the sensor module includes: an amplifying circuit, configured to amplify the electric signal.

Further, the processor is further configured to control, after recognizing the electric signal, the loudspeaker to play the acoustic signal.

A voice control system is further provided according to another aspect of the embodiments of the disclosure, including: a controlled device; the voice recognition device, connected with the controlled device and configured to receive an acoustic signal and control the controlled device according to the acoustic signal.

A voice communication system is further provided according to still another aspect of the embodiments of the disclosure, including: a first voice recognition device, wherein the first voice recognition device is the foregoing voice recognition device and configured to output an acoustic signal; and a second voice recognition device, wherein the second recognition device is the foregoing voice recognition device and configured to receive the acoustic signal, recognize the acoustic signal and output a response acoustic signal to the first voice recognition device.

Further, the first voice recognition device includes a first loudspeaker and a first processor; the first processor is configured to control the first loudspeaker to play the acoustic signal; the second voice recognition device includes a second loudspeaker and a second processor, wherein the second loudspeaker is configured to receive the acoustic signal, and convert the acoustic signal into an electric signal; the second processor is configured to recognize the electric signal and control the second loudspeaker to play the response acoustic signal to the first loudspeaker.

In the embodiments of the disclosure, a loudspeaker is used as a sound receiver to receive an acoustic signal, so that the loudspeaker may function as a sound reproducer to perform sound reproduction, and may also function as an acoustic sensor to receive the acoustic signal, thereby implementing voice recognition without a sound receiver. A voice recognition device according to the embodiments of the disclosure is applied in a voice control product to reduce components of the product, thus solving the technical problem that the voice control product contains many devices, and is structure complicatedly.

### BRIEF DESCRIPTION OF THE DRAWINGS

The accompanying drawings illustrated herein are used for providing further understanding to the disclosure and constitute a part of the application. The exemplary embodiments of the disclosure and illustration thereof are used for explaining the disclosure, instead of constituting improper limitation to the disclosure. In the accompanying drawings:

FIG. 1 is a structural diagram of a voice recognition device according to an embodiment of the disclosure; and

FIG. 2 is a schematic diagram of a voice control system according to an embodiment of the disclosure.

### DETAILED DESCRIPTION OF THE EMBODIMENTS

The technical solutions in the embodiments of the disclosure will be described clearly and completely below with reference to the accompanying drawings in the embodiments of the disclosure so as to enable those skilled in the art to better understand the solutions of the disclosure. Obviously, the described embodiments are merely a part rather than all of the embodiments of the disclosure. All other embodiments obtained by a person of ordinary skill in the art based on the embodiments in the disclosure without creative efforts shall belong to the protection scope of the disclosure.

It needs to be noted that the terms “first,” “second,” and the like in the specification, claims, and the accompanying drawings of the disclosure are used for differentiating similar objects, and are not necessarily used for describing a specific sequence or order. It should be understood that data used in this way is interchangeable if appropriate, so that the embodiments of the disclosure described herein may be implemented in a sequence except those shown or described herein. In addition, the terms “include,” “have,” and any variants of them are intended to cover non-exclusive inclusion. For example, processes, methods, systems, products, or devices that include a series of steps or units are not necessarily limited to the steps or units that are clearly listed, but may also include other steps or units that are not clearly listed or are inherent in these processes, methods, products, or devices.

An embodiment of a voice recognition device is provided according to the embodiments of the disclosure.

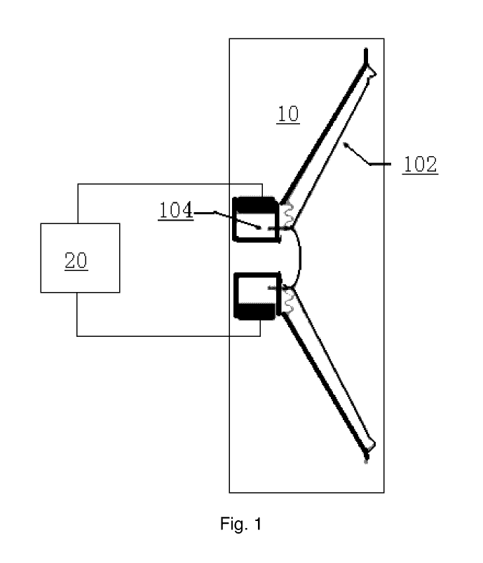

FIG. 1 is a structural diagram of a voice recognition device according to an embodiment of the disclosure. As shown in FIG. 1, the voice recognition device includes: a loudspeaker 10 and a processor 20.

The loudspeaker 10 includes: a vibration unit 102, configured to receive an acoustic signal; and a conversion unit 104, configured to convert the acoustic signal into an electric signal. The processor 20 is connected with the conversion unit 104 and configured to receive the electric signal and recognize the electric signal.

In the embodiment of the disclosure, the vibration unit 102 may be configured to generate a sound through vibration, and may be further configured to generate the vibration when receiving the acoustic signal. Specifically, the loudspeaker 10 controls, when playing the sound, the vibration unit 102 to generate the vibration so that resonance is generated by the air surrounding the vibration unit, thereby generating the sound. When the loudspeaker 10 receives the acoustic signal, the acoustic signal is transmitted to the vibration unit 102 so that the vibration unit 102 generates the vibration. The conversion unit 104 further converts the vibration generated by the vibration unit 102 into the electric signal, so as to convert the acoustic signal into the electric signal. The conversion unit 104 transmits the generated electric signal to the processor 20, and based on the electric signal, the processor 20 recognizes a content of the acoustic signal received by the loudspeaker.

According to the embodiment of the disclosure, the loudspeaker functions as a sound receiver to receive the acoustic signal so that the loudspeaker may function as a sound reproducer to perform sound reproduction, and may also function as an acoustic sensor to receive the acoustic signal, thereby implementing voice recognition without a sound receiver (a microphone). The voice recognition device of the embodiment of the disclosure may be applied in a voice control product to solve the technical problem that the voice control product contains many devices, and is structured complicatedly, and reduce components of the product.

It needs to be noted that the voice recognition device of the embodiment of the disclosure is more applicable to a voice control product having a small volume, so as to use fewer components while reducing cost, wherein the loudspeaker refers to a device capable of converting an electric signal into an acoustic signal, including a horn, an earphone and so on, which is not limited improperly by the disclosure.

Preferably, the processor is further configured to control, after recognizing the electric signal, the loudspeaker to play the acoustic signal, so that a user can determine whether the acoustic signal is a required control signal, wherein the acoustic signal played by the loudspeaker may be the recognized acoustic signal, and may be also a customized acoustic signal. The customized acoustic signal may function as a response to the received acoustic signal.

The vibration unit 102 may be a new element in the loudspeaker, and may be also an original component of the loudspeaker. Preferably, the vibration unit 102 includes: a diaphragm, configured to receive the acoustic signal and generate the vibration. The vibration unit 102 may be a diaphragm of the loudspeaker and the acoustic signal is sensed by the diaphragm. Further, the diaphragm is at least one of the followings: a cone, a paper-based diaphragm, a metal diaphragm, a polymer diaphragm, a composite diaphragm, and so on.

Preferably, the conversion unit 104 includes: a voice coil, fixedly arranged with the diaphragm and vibrating with the vibration of the diaphragm, wherein the voice coil generates the electric signal when vibrating with the diaphragm.

The voice coil may be also called as a coil. The voice coil may be placed in a magnetic gap formed by a magnetically conductive core column and a magnetically conductive plate, and fixed with the diaphragm, wherein the diaphragm drives, when sensing the acoustic signal and generates the vibration, the voice coil to vibrate together, so that the voice coil moves in the magnetic gap to generate an electric current, i.e. the electric signal. The processor 20 may receive the electric signal directly, or receives the electric signal having been subjected to processing including amplification and so on, and recognizes the electric signal subsequently.

The diaphragm is illustrated in the embodiment of the disclosure by taking a cone as an example. When the loudspeaker receives a sound, the cone will vibrate to cause a change in a magnetic field, the voice coil of the loudspeaker will generate a weak electric signal, and an acoustic signal may be recognized by receiving and processing such a weak electric signal.

Preferably, the voice recognition device further includes: a sensor module, connected between the processor and the conversion unit and configured to convert the electric signal into a pulse sequence and output the pulse sequence to the processor.

The sensor module is configured to receive the electric signal converted by the loudspeaker, convert the signal into the pulse sequence, and then output the pulse sequence. The outputted pulse sequence can waken the processor, and the processor can recognize the pulse sequence by a software program, and determine, according to a requirement, whether to perform sound reproduction.

Further, the sensor module includes: an amplifying circuit, configured to amplify the electric signal. After receiving the electric signal, the amplifying circuit amplifies the electric signal to obtain the pulse sequence. Alternatively, the sensor module may further include a comparison circuit configured to process the electric signal accordingly.

An embodiment of the disclosure further provides a voice control system.

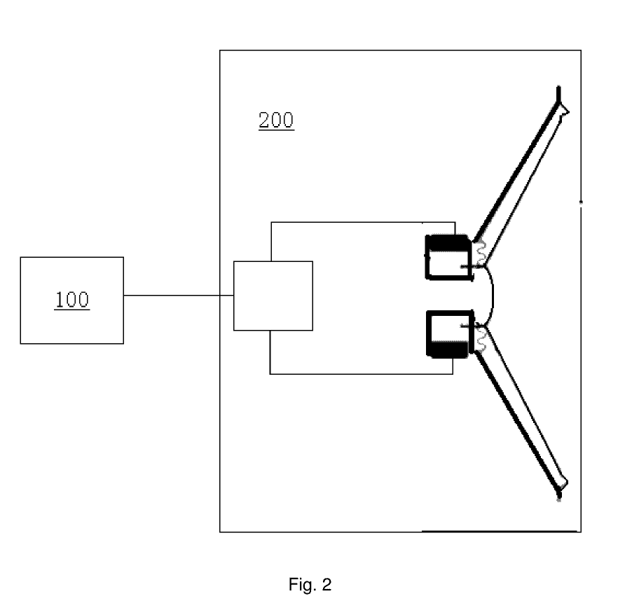

As shown in FIG. 2, the voice control system includes: a controlled device 100 and a voice recognition device 200.

The voice recognition device 200 is connected with the controlled device 100 and configured to receive an acoustic signal and control the controlled device 100 according to the acoustic signal.

The voice recognition device 200 may be the voice recognition device provided in the foregoing embodiment of the disclosure. The voice recognition device 200 receives the acoustic signal, recognizes the acoustic signal, and outputs a control signal so as to control the controlled device 100. The controlled device 100 may be a miniaturized component, and may be also a device, which is not limited by the embodiment of the disclosure.

An embodiment of the disclosure further provides a voice communication system. The voice communication system includes: a first voice recognition device and a second voice recognition device.

The first voice recognition device is configured to output an acoustic signal. The second voice recognition device is configured to receive the acoustic signal, recognize the acoustic signal and output a response acoustic signal to the first voice recognition device.

The first voice recognition device and the second voice recognition device may be the voice recognition device provided by the embodiment of the disclosure, and two or more voice recognition devices may communicate acoustically.

Further, the first voice recognition device includes a first loudspeaker and a first processor; the first processor is configured to control the first loudspeaker to play the acoustic signal; the second voice recognition device includes a second loudspeaker and a second processor, wherein the second loudspeaker is configured to receive the acoustic signal, and convert the acoustic signal into an electric signal; the second processor is configured to recognize the electric signal and control the second loudspeaker to play the response acoustic signal to the first loudspeaker.

When functioning as a sound receiver, a loudspeaker in the embodiment of the disclosure may receive an acoustic wave, and may also sense a change in a magnetic field around the device (e.g. the magnetic field will change when the device is approached) so as to perform communication.

Specifically, a coil of the loudspeaker will also generate a weak electric signal when an electromagnetic field of an environment changes and communication may be implemented by receiving and processing such a weak electric signal. For example, an electric signal of a frequency is provided to a loudspeaker, and a changed electromagnetic field may be generated by a coil of the loudspeaker. A coil of the other loudspeaker receives such a change in the electromagnetic field to form a weak electric signal, thereby implementing mutual communication.

The above are only preferred embodiments of the disclosure. It should be pointed out that several improvements and modifications may be further made without departing from the principles of the disclosure for those of ordinary skill in the art. These improvements and modifications shall be also regarded as the protection scope of the disclosure.

What is claimed is:

1. A voice recognition device, comprising:
a loudspeaker, the loudspeaker comprises: a vibration unit, configured to receive an acoustic signal; a conversion unit, configured to convert the acoustic signal into an electric signal; and
a processor, connected with the conversion unit and configured to receive the electric signal and recognize the electric signal.

2. The voice recognition device according to claim 1, wherein the vibration unit comprises:
a diaphragm, configured to receive the acoustic signal and generate vibration.

3. The voice recognition device according to claim 2, wherein the diaphragm is at least one of the followings: a cone, a paper-based diaphragm, a metal diaphragm, a polymer diaphragm and a composite diaphragm.

4. The voice recognition device according to claim 2, wherein the conversion unit comprises:
a voice coil, fixedly arranged with the diaphragm and vibrating with the vibration of the diaphragm,
wherein, the voice coil generates the electric signal when vibrating with the diaphragm.

5. The voice recognition device according to claim 1, wherein the voice recognition device further comprises:
a sensor module, connected between the processor and the conversion unit and configured to convert the electric signal into a pulse sequence and output the pulse sequence to the processor.

6. The voice recognition device according to claim 5, wherein the sensor module comprises:
an amplifying circuit, configured to amplify the electric signal.

7. The voice recognition device according to claim 1, wherein
the processor is further configured to control, after recognizing the electric signal, the loudspeaker to play the acoustic signal.

8. A voice control system, comprising:
a controlled device;
the voice recognition device according to claim 1, connected with the controlled device and configured to receive an acoustic signal and control the controlled device according to the acoustic signal.

9. A voice communication system, comprising:
a first voice recognition device, wherein the first voice recognition device is the voice recognition device according to claim 1 and configured to output an acoustic signal; and
a second voice recognition device, wherein the second recognition device is the voice recognition device according to claim 1 and configured to receive the acoustic signal, recognize the acoustic signal and output a response acoustic signal to the first voice recognition device.

10. The voice communication system according to claim 9, wherein
the first voice recognition device comprises a first loudspeaker and a first processor, the first processor is configured to control the first loudspeaker to play the acoustic signal;
the second voice recognition device comprises a second loudspeaker and a second processor, wherein the second loudspeaker is configured to receive the acoustic signal, and convert the acoustic signal into an electric signal; the second processor is configured to recognize the electric signal and control the second loudspeaker to play the response acoustic signal to the first loudspeaker.

11. The voice recognition device according to claim 3, wherein the conversion unit comprises:
a voice coil, fixedly arranged with the diaphragm and vibrating with the vibration of the diaphragm,
wherein, the voice coil generates the electric signal when vibrating with the diaphragm.

12. A voice control system, comprising:
a controlled device;
the voice recognition device according to claim 2, connected with the controlled device and configured to receive an acoustic signal and control the controlled device according to the acoustic signal.

13. A voice control system, comprising:
a controlled device;
the voice recognition device according to claim 3, connected with the controlled device and configured to receive an acoustic signal and control the controlled device according to the acoustic signal.

14. A voice control system, comprising:
a controlled device;
the voice recognition device according to claim 4, connected with the controlled device and configured to receive an acoustic signal and control the controlled device according to the acoustic signal.

15. A voice control system, comprising:
a controlled device;
the voice recognition device according to claim 5, connected with the controlled device and configured to receive an acoustic signal and control the controlled device according to the acoustic signal.

16. A voice control system, comprising:
a controlled device;
the voice recognition device according to claim 6, connected with the controlled device and configured to receive an acoustic signal and control the controlled device according to the acoustic signal.

17. A voice control system, comprising:
a controlled device;
the voice recognition device according to claim 7, connected with the controlled device and configured to receive an acoustic signal and control the controlled device according to the acoustic signal.
